(19) United States
(12) Patent Application Publication
(10) Pub. No.: US 2011/0305879 A1
(43) Pub. Date: Dec. 15, 2011

(54) COMPONENT

(75) Inventor: Jan Reinmann, Straufhain (DE)

(73) Assignee: RÖSLER HOLDING GmbH & CO KG, Bad Staffelstein (DE)

(21) Appl. No.: 13/147,276

(22) PCT Filed: Jan. 26, 2010
(86) PCT No.: PCT/EP2010/000449

§ 371 Date: Sep. 6, 2011

(30) Foreign Application Priority Data
Feb. 3, 2009 (DE) 10 2009 007 174.1

(51) Int. Cl. C01B 31/06; B32B 19/00; B23P 25/00

(52) U.S. Cl. 428/195.1; 29/458; 423/446; 428/688; 428/332

(57) ABSTRACT

A component that is subject to tribological wear comprises a nano diamond layer on the surface thereof.

The present invention relates to a component of blasting or grinding technology which is subject to tribological wear. Such components, which are, for example, used in blasting plant serve, for example, for the acceleration of blast media or for the protection against accelerated blast media. Steel castings, stainless steel castings, chill castings, wire shot, cast aluminum alloys, wrought aluminum alloys, zinc cuts, brass cuttings, plastics, glass beads, mineral materials or dry ice are inter alia used as blast media. Compressed air blasting systems or centrifugal wheels can be used to accelerate blast media, with the blast media first being pre-accelerated by said rotary wheels, then being accelerated again and being cast off by thrower blades. Individual components of such centrifugal wheels are in so doing subject to high tribological wear.

It is the object of the invention to provide a component of the initially named kind which has an increased service life.

This object is satisfied by the features of claim 1 and in particular in that at least one part of the surface of the component is provided with a nanodiamond layer. The wear resistance of the component is hereby substantially increased so that its service life is increased.

Advantageous embodiments of the invention are described in the description and in the dependent claims.

In accordance with a first advantageous embodiment, only a part of the surface of the component can be provided with the nanodiamond layer, which results in an inexpensive manufacture since only the regions of the component exposed to special wear are provided with the nanodiamond layer.

In accordance with a further embodiment of the invention, the nanodiamond layer can be deposited directly onto the component, for example by chemical vapor deposition (CVD). It is alternatively possible to deposit the nanodiamond layer onto a carrier material and subsequently to connect the carrier material having the nanodiamond layer thereon to the component, for example by bonding, soldering or welding, e.g. ultrasound welding. The advantage results in this last embodiment variant that a considerably better resistance to cracking, breakage or peeling is achieved by the provision of the carrier material, i.e. the nanodiamond layer is not completely or partly destroyed in blasting operation when kinetic energy is introduced at single points by the blasting process.

In accordance with a further advantageous embodiment, the nanodiamond layer can first be applied to a carrier material and can subsequently be released from the carrier material. A nanodiamond layer is hereby provided which only consists of the diamond material and this layer can then in turn be connected to the component.

It is advantageous if the nanodiamond layer has a thickness of at least 20 μm. The maximum thickness of the nanodiamond layer can be approximately 2000 μm.

In accordance with the invention, a method is also provided of manufacturing a component of the above-described kind, wherein a nanodiamond layer is deposited on a carrier material, the deposited nanodiamond layer is released from the carrier layer and the nanodiamond layer released from the carrier material is connected to the component. It can be advantageous in this respect if the nanodiamond layer is deposited on the carrier material in such a thickness that it is flexible or film-like after the release from the carrier material. In this manner, a formable diamond layer can be provided which can be adapted to a surface contour of the component on the application to the component. The connection of the nanodiamond layer to the component can take place by bonding, soldering, welding, ultrasound welding or other suitable processes.

A further method in accordance with the invention of manufacturing a component of the above-described kind has the steps that a nanodiamond layer is deposited on a carrier material and subsequently the carrier material having the nanodiamond layer thereon is connected to the component. It can be advantageous in this respect if the carrier material is adapted to the surface design of the component by shaping before the deposition of the nanodiamond layer. Any desired three-dimensional geometries can hereby be reproduced before the deposition of the nanodiamond layer which are curved or also angled, with subsequently the carrier material being coated with the nanodiamond layer. After the coating, the carrier material provided with the nanodiamond layer can be connected to the component.

An advantageous carrier material can be formed by a metal film.

A further method of manufacturing a component of the above-described kind has the steps that a nanodiamond layer is deposited on a first carrier material, the deposited nanodiamond layer is subsequently released from the first carrier material, the nanodiamond layer released from the first carrier material is connected to a second carrier material and finally the compound structure of the second carrier material and the nanodiamond layer is connected to the component. In this method, the application of the nanodiamond layer to the component can be optimized in that respective selected materials are used for the two carrier materials. A material can thus be selected as the first carrier material which is well-suited for the deposition of the nanodiamond layer, for example a copper film. Furthermore, a double-layer coating can be obtained by the connection of the nanodiamond layer to the second carrier material in which the second carrier material provides an improved connection and an improved cohesion of the nanodiamond layer so that the nanodiamond layer is considerably more resistant to peeling. Films of plastic, metal, minerals or other materials can be used as the second carrier material or as connection films. The connection of the double-layer material created in this manner to the component can be carried out by bonding, welding, ultrasound, soldering or also by self-adhesive films. It is equally possible to provide a layer of spray adhesive as the second carrier material or to apply a different kind of adhesive layer by which then a fastening to the component can take place directly.

Embodiments of the invention will be described purely by way of example in the following.

In accordance with a first embodiment variant, a nanodiamond layer can be deposited onto a carrier material in the form of a copper sheet, with the copper sheet first being ground and polished at the surfaces to achieve a starting surface which is as smooth and as planar as possible. A smooth and flawless lower side of the nanodiamond layer is hereby ensured during the growing in the CVD process after a diamond seeding by application of nanodiamond in the ultrasound bath. Since the diamond layers produced in this manner have no chemical or mechanical bond to the copper surface, they peel off easily on a subsequent cooling. Any desired geometries can be produced from the nanodiamond layer released with the aid of a short-pulse laser, for example.

In an alternative embodiment of the invention, a metal film is provided with the nanodiamond layer and the metal film having the nanodiamond layer thereon is subsequently connected to the component. A substantially improved resistance to impact loads is hereby provided since no damage to the nanodiamond layer takes place even with kinetic energy introduced at points due to the carrier material in the form of the metal film.

In accordance with a further embodiment variant of the invention, a copper film or another metal film can first be used as the first carrier material, either planar or shaped in different geometries, to provide this film with a nanodiamond layer. A diamond seeding of the film first takes place for this purpose and subsequently a CVD deposition on the copper film. After a cooling of the nanodiamond layer created in this manner, it can easily be released from the copper film, with the original contour being maintained. Subsequently, the nanodiamond layer obtained in this manner can be applied to a flexible carrier material, for example to connection films comprising plastic, metal, minerals or the like, or such an additional carrier material is applied to the nanodiamond layer, for example by spraying or brushing. Finally, the double-layer created in this manner comprising the nanodiamond layer and the second carrier material is connected to the component to be protected, for example by bonding, welding, ultrasound, soldering or by use of self-adhesive films or spray adhesives.

In the field of centrifugal wheels, the nanodiamond layer can be applied to wear plates, dispensers, accelerators, thrower blades and the like, whereby a substantially improved service life can be achieved.

1-19. (canceled)

20. A component of blasting technology or grinding technology which is subject to tribological wear, wherein at least a part of a surface of the component is provided with a nanodiamond layer.

21. The component in accordance with claim 20, wherein only a part of the surface of the component is provided with the nanodiamond layer .

22. The component in accordance with claim 20, wherein the nanodiamond layer is deposited directly onto the component.

23. The component in accordance with claim 20, wherein the nanodiamond layer is deposited onto a carrier material, and wherein the carrier material having the nanodiamond layer thereon is connected to the component.

24. The component in accordance with claim 23, wherein the carrier material having the nanodiamond layer thereon is connected to the component by bonding, soldering or welding.

25. The component in accordance with claim 20, wherein the nanodiamond layer is deposited onto a carrier material; and wherein the nanodiamond layer released from the carrier material is connected to the component.

26. The component in accordance with claim 25, wherein the nanodiamond layer released from the carrier material is connected to the component by bonding, soldering or welding.

27. The component in accordance with claim 20, wherein the nanodiamond layer is deposited onto a first carrier material; wherein the nanodiamond layer released from the first carrier material is applied to a second carrier material; and
wherein the second carrier material having the nanodiamond layer thereon is connected to the component.

28. The component in accordance with claim 27, wherein the second carrier material having the nanodiamond layer thereon is connected to the component by bonding, soldering or welding.

29. The component in accordance with claim 27, wherein the second carrier material is a plastic film.

30. The component in accordance with claim 20, wherein the nanodiamond layer has a thickness of approximately 20-2000 μm.

31. The component in accordance with claim 20, wherein it is a component of a centrifugal arrangement.

32. The component in accordance with claim 20, wherein it is a component of a thrower blade.

33. A method of manufacturing a component, wherein at least a part of a surface of the component is provided with a nanodiamond layer, with the
nanodiamond layer being deposited on a carrier material;
the deposited nanodiamond layer is released from the carrier material; and
the nanodiamond layer released from the carrier material is connected to the component.

34. The method in accordance with claim 33, wherein the nanodiamond layer is deposited on the carrier material in such a thickness that it is flexible or film-like after the release from the carrier material.

35. The method in accordance with claim 33, wherein the nanodiamond layer is deposited with a thickness of approximately 20-2000 μm.

36. The method in accordance with claim 33, wherein the nanodiamond layer released from the carrier material is connected to the component by bonding, soldering, welding or ultrasound welding.

37. The method in accordance with claim 33, wherein a metal film is used as the carrier material.

38. A method of manufacturing a component, wherein at least a part of a surface of the component is provided with a nanodiamond layer, with the
nanodiamond layer being deposited on a carrier material; and
wherein the carrier material having the nanodiamond layer thereon is connected to the component.

39. The method in accordance with claim 38, wherein the carrier material is adapted to the surface design of the component by shaping before the depositing of the nanodiamond layer.

40. The method in accordance with claim 38, wherein the carrier material having the nanodiamond layer thereon is connected to the component by bonding, soldering, welding or ultrasound welding.

41. A method of manufacturing a component wherein at least a part of a surface of the component is provided with a nanodiamond layer, wherein a
nanodiamond layer is deposited on a first carrier material;
the deposited nanodiamond material is released from the first carrier material;
the nanodiamond layer released from the first carrier material is connected to a second carrier material; and
the compound structure of the second carrier material and the nanodiamond layer is connected to the component.

42. The method in accordance with claim 41, wherein a plastic film is used as the second carrier material.

43. The method in accordance with claim 41, wherein a metal film is used as the first carrier material.
